(19) United States
(12) Patent Application Publication
(10) Pub. No.: US 2024/0124998 A1
(43) Pub. Date: Apr. 18, 2024

(54) METHOD FOR PREPARING METALLIC TITANIUM USING TITANIUM-CONTAINING OXIDE SLAG

(71) Applicant: KUNMING UNIVERSITY OF SCIENCE AND TECHNOLOGY, Kunming City (CN)

(72) Inventors: Yun LEI, Kunming City (CN); Shiding WANG, Kunming City (CN); Dongfang YANG, Kunming City (CN); Wenhui MA, Kunming City (CN); Zhanchao LI, Kunming City (CN); Yakun ZHANG, Kunming City (CN)

(21) Appl. No.: 18/397,411

(22) Filed: Dec. 27, 2023

(30) Foreign Application Priority Data
May 12, 2023 (CN) 2023105451764

(51) Int. Cl. C25C 3/28; C22B 34/12

(52) U.S. Cl. CPC C25C 3/28; C22B 34/1277; C22B 34/1295

(57) ABSTRACT

The titanium-containing oxide slag, low-purity silicon and slagging fluxes are subject to reduction smelting together, and a bulk Si—Ti intermediate alloy is obtained by slag-metal separation; the obtained bulk Si—Ti intermediate alloy is crushed into Si—Ti intermediate alloy particles; and the obtained Si—Ti intermediate alloy particles are used as an anode, metallic molybdenum or metallic nickel as a cathode, metallic titanium as a reference electrode, and NaCl—KCl—NaF together with small amounts of Na₃TiF₆ or K₃TiF₆ as a molten salt, to carry out the electrolysis under a high-purity argon atmosphere at a temperature of 973 K. Ti in the Si—Ti intermediate alloy particles dissolved at the anode and deposited at the cathode, while Si in the Si—Ti intermediate alloy particles fell off from the anode as metallic silicon powder.

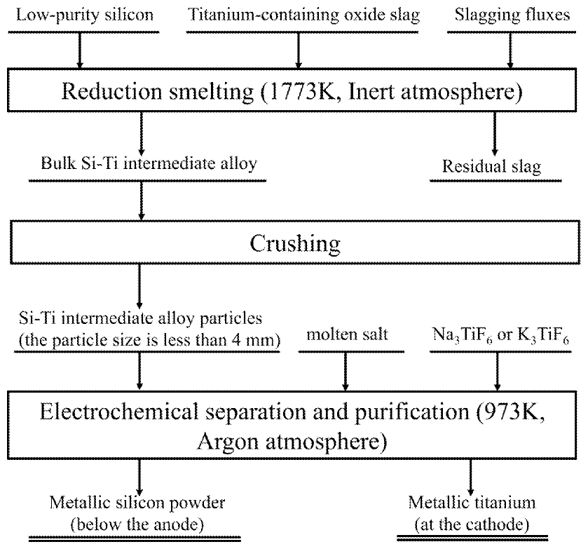

### TECHNICAL FIELD

The invention relates to a method for preparing metallic titanium using titanium-containing oxide slag, and belongs to the technical field of clean utilization of resources.

### BACKGROUND

Titanium and titanium alloys have the advantages of light weight, high strength, corrosion resistance, heat resistance and so on. They are new structural materials and have a wide range of influence in aerospace, chemical, petroleum, light industry, metallurgy and other industries. At present, there are about 140 titanium ores, but rutile (TiO₂) and ilmenite (FeTiO₃) are mainly used in industry. China is rich in titanium resources, and the reserve of titanium resources is at the forefront of the world. China's titanium ore is mainly composed of ilmenite with a reserve of 200 million tons, ranking first in the world. Among them, primary vanadium titano-magnetite is the main industrial type in China. The vanadium titano-magnetite in China is mainly distributed in Panzhihua region. During smelting of the vanadium titano-magnetite, the vanadium titano-magnetite is firstly concentrated by mineral separation to obtain vanadium-titanium magnetite concentrate which is then subject to blast furnace smelting to obtain vanadium-containing hot metal and titanium-containing blast furnace slag. Since titanium in the vanadium-titanium magnetite concentrate is not readily reduced by carbon into the hot metal, the titanium in the vanadium-titanium magnetite concentrate mainly remains in the blast furnace slag to form low-grade titanium-containing blast furnace slag with TiO₂ of about 20% to 25%. Due to low grade and complex composition of TiO₂ in titanium-containing blast furnace slag, there is no effective method for effectively utilizing titanium-containing blast furnace slag. The amount of titanium-containing blast furnace slag accumulated in Panzhihua region is close to 100 million tons, not only causing severe waste of titanium resources, but also polluting the environment. Extracting titanium from the titanium-containing blast furnace slag using silicon as a reductant to obtain a silicon-titanium alloy is one of the current methods for utilizing the titanium-containing blast furnace slag. However, the obtained silicon-titanium alloy has a variety of impurities with high contents, resulting in very limited use and consumption. The obtained silicon-titanium alloy can only be used as a deoxidizer or alloying agent for steelmaking, which limits the further development and industrial application of the silicon reduction method.

With regard to the problem of how to use silicon to reduce the titanium-containing blast furnace slag to prepare the silicon-titanium alloy, patent No. ZL202010184003.0 proposes a method for preparing high-purity silicon, titanium pigment and a high-purity fluoride using titanium-containing slag and a low-purity silicon material, which specifically comprises the following steps: extracting titanium from titanium-containing blast furnace slag using low-purity silicon as a reductant to obtain a silicon-titanium intermediate alloy; crushing the silicon-titanium intermediate alloy into powder; and pickling the silicon-titanium intermediate alloy using an HF-containing acid to realize wet separation of the silicon-titanium alloy, resulting in the high-purity silicon, the titanium pigment and the high-purity fluoride. Patent No. ZL201811323583.6 proposes a method for preparing titanium, silicon and a titanium-silicon alloy from titanium-containing slag, which specifically comprises the following steps: extracting titanium from titanium-containing blast furnace slag using low-purity silicon as a reductant to obtain a silicon-titanium alloy, and then separating and purifying the silicon-titanium alloy using physical methods such as electromagnetic directional crystallization to obtain silicon, a titanium-silicon intermetallic compound or an eutectic silicon-titanium alloy. Regardless of whether the silicon-titanium alloy is separated by pickling or physical methods, the existing methods cannot simultaneously separate silicon and titanium from the silicon-titanium intermediate alloy obtained by reducing the titanium-containing blast furnace slag with silicon into metallic titanium and metallic silicon, which is also a technical problem to be solved.

### SUMMARY

In view of the above-mentioned technical problems, the present invention provides a method for preparing metallic titanium using titanium-containing oxide slag. Unlike patent Nos. ZL202010184003.0 and ZL201811323583.6, the present invention innovatively combines the silicon reduction method with the molten salt electrolysis method and provides for the first time a method for separating a silicon-titanium intermediate alloy obtained by reducing titanium-containing oxide slag with silicon into metallic titanium and metallic silicon powder, thereby achieving clean utilization of the titanium-containing oxide slag or scrap. The present invention is realized by the following technical scheme.

A method for preparing metallic titanium using titanium-containing oxide slag, comprises the following steps:
step 1, performing reduction smelting on titanium-containing oxide slag, low-purity silicon and slagging fluxes together at a temperature of 1773 K under an inert atmosphere for more than 4 hours, and performing slag-metal separation to obtain a bulk Si—Ti intermediate alloy and a residual slag; and controlling a mass ratio of the titanium-containing oxide slag to the low-purity silicon during the reduction smelting, so that main phases in the obtained bulk Si—Ti intermediate alloy are titanium-silicon intermetallic compounds TiSix, 0<x≤2;
step 2, crushing the bulk Si—Ti intermediate alloy obtained in the step 1 into Si—Ti intermediate alloy particles with a particle size less than 4 mm;
step 3, using the Si—Ti intermediate alloy particles obtained in the step 2 as an anode, metallic molybdenum or metallic nickel as a cathode, metallic titanium as a reference electrode, and NaCl—KCl—NaF as a molten salt, adding Na₃TiF₆ or K₃TiF₆ to the molten salt, and performing molten salt electrolysis under a high-purity argon atmosphere (99.999%) at a temperature of 973 K while controlling the valence state of titanium as +3 to allow the cathode to precipitate metallic titanium and the metallic silicon powder fell off from the anode.

The titanium-containing oxide slag in the step 1 is oxide slag or scrap containing TiO₂, comprising titanium-containing blast furnace slag or a spent SCR catalyst.

The low-purity silicon in the step 1 is a silicon material with metallic silicon as a main component, comprising a silicon alloy, industrial silicon or diamond wire saw silicon powder (Si sludge) generated from the photovoltaic industry.

The slagging fluxes in the step 1 is a mixture of one or more of CaO, SiO₂, MgO and Al₂O₃ in a suitable proportion.

A ratio of NaCl, KCl and NaF in the NaCl—KCl—NaF molten salt in the step 3 is not limited.

A molar ratio of NaCl:KCl:NaF in the NaCl—KCl—NaF molten salt is 50.6:49.4:5.

Na₃TiF₆ or K₃TiF₆ is added to the molten salt in the step 3 in any molar percentage.

Na₃TiF₆ or K₃TiF₆ is added to the molten salt in the step 3 in a molar percentage of 1 mol %.

The molten salt electrolysis in the step 3 is performed by a galvanostatic method or a potentiostatic method, preferably the potentiostatic method.

The time for the electrochemical separation and purification in the molten salt electrolysis in the step 3 is not limited.

The present invention has the following beneficial effects:
(1) The existing molten salt chemical method for preparing metallic titanium is to directly electrolyze TiO₂ into metallic titanium, while the present invention uses the silicon-titanium alloy obtained by reducing the low-grade titanium-containing oxide slag or scrap with low-purity silicon as an intermediate product, and then uses the silicon-titanium intermediate alloy as a raw material to obtain metallic titanium and metallic silicon powder using a molten salt electrochemical method. Therefore, the present invention is a method for treating low-grade titanium-containing oxide slag or scrap;
(2) The present invention can simultaneously result in two products namely the metallic titanium and the metallic silicon powder, where the metallic titanium is derived from the low-grade titanium-containing oxide slag or scrap containing TiO₂, and the metallic silicon powder can be derived from the low-purity silicon waste (diamond wire saw silicon powder, or Si sludge, generated from the photovoltaic industry). Therefore, the present invention is a method for simultaneously preparing metallic titanium and metallic silicon powder from a large amount of accumulated and untreatable titanium-containing waste and silicon wastes (diamond wire saw silicon powder or Si sludge), which has high economic and environmental benefits; and
(3) Neither waste acid nor waste gas is generated in the entire process of the present invention, and the present invention is a new environmentally-friendly technology.

### BRIEF DESCRIPTION OF THE DRAWINGS

The sole FIGURE is a schematic flow diagram of the present invention.

### DESCRIPTION OF THE EMBODIMENTS

The present invention will be further described below with reference to the accompanying drawings and specific embodiments.

### Embodiment 1

As shown in the sole FIGURE, the method for preparing metallic titanium using titanium-containing oxide slag comprised the following steps:
step 1, titanium-containing oxide slag (titanium-containing blast furnace slag from Panzhihua region, with a TiO₂ content of 20 wt. %), low-purity silicon (industrial silicon, with a Si content of 99.3 wt. %) and a slagging flux (MgO) were subject to reduction smelting together at a temperature of 1773 K under an argon atmosphere for 4 hours, and a bulk Si—Ti intermediate alloy and a residual slag were obtained by slag-metal separation. During the reduction smelting, a mass ratio of the titanium-containing oxide slag to the low-purity silicon was controlled to be 10:3, and the MgO was added in such an amount to saturate the MgO in the titanium-containing blast furnace slag. The main phase in the bulk Si—Ti intermediate alloy was a titanium-silicon intermetallic compound TiSi₂ with a Ti content of 39 wt. %;
step 2, the bulk Si—Ti intermediate alloy obtained in the step 1 was crushed into Si—Ti intermediate alloy particles with a particle size less than 4 mm;
step 3, the Si—Ti intermediate alloy particles obtained in the step 2 were used as an anode, metallic molybdenum as a cathode, metallic titanium as a reference electrode, NaCl—KCl—NaF (with a molar ratio of NaCl:KCl:NaF being 50.6:49.4:5) as a molten salt, and 1 mol % Na₃TiF was added to the molten salt to control a valence state of titanium to +3 during molten salt electrolysis which was carried out under a high-purity argon atmosphere (99.999%) at a temperature of 973 K by a potentiostatic method (with a constant potential of 400 mV). In the electrochemical process of the molten salt, Ti in the Si—Ti intermediate alloy particles dissolved at the anode and deposited at the cathode, while Si in the Si—Ti intermediate alloy particles fell off from the anode as metallic silicon powder; and
step 4, the anode and the cathode in the step 3 were taken out of the molten salt under high-purity argon (99.999%), and the metallic silicon powder and the metallic titanium can be obtained below the anode and at the cathode respectively.

### Embodiment 2

As shown in the sole FIGURE, the method for preparing metallic titanium using titanium-containing oxide slag comprised the following steps:
step 1, titanium-containing oxide slag (titanium-containing blast furnace slag from Panzhihua region, with a TiO₂ content of 20 wt. %), low-purity silicon (an eutectic silicon-titanium alloy, with a Si content of 75.5 wt. % and a Ti content of 21.6 wt. %) and a slagging flux (MgO) were subject to reduction smelting together at a temperature of 1773 K under an argon atmosphere for 4 hours, and a bulk Si—Ti intermediate alloy and a residual slag were obtained by slag-metal separation. During the reduction smelting, a mass ratio of the titanium-containing oxide slag to the low-purity silicon was controlled to be 3:1, and the MgO was added in such an amount to saturate the MgO in the titanium-containing blast furnace slag. The main phases in the bulk Si—Ti intermediate alloy were titanium-silicon intermetallic compounds TiSi and TiSi₂ with a Ti content of 60.2 wt. %;
step 2, the bulk Si—Ti intermediate alloy obtained in the step 1 was crushed into Si—Ti intermediate alloy particles with a particle size less than 4 mm;
step 3, the Si—Ti intermediate alloy particles obtained in the step 2 were used as an anode, metallic nickel as a cathode, metallic titanium as a reference electrode, NaCl—KCl—NaF (with a molar ratio of NaCl:KCl:NaF being 50.6:49.4:5) as a molten salt, and 1 mol % Na₃TiF was added to the molten salt to control a valence state of titanium to +3 during molten salt electrolysis which was carried out under a high-purity argon atmosphere (99.999%) at a temperature of 973 K by a potentiostatic method (with a constant potential of 300 mV). In the electrochemical process of the molten salt, Ti in the Si—Ti intermediate alloy particles dissolved at the anode and deposited at the cathode, while Si in the Si—Ti intermediate alloy particles fell off from the anode as metallic silicon powder; and
step 4, the anode and the cathode in the step 3 were taken out of the molten salt under high-purity argon (99.999%), and the metallic silicon powder and the metallic titanium can be obtained below the anode and at the cathode respectively.

### Embodiment 3

As shown in the sole FIGURE, the method for preparing metallic titanium using titanium-containing oxide slag comprised the following steps:
step 1, titanium-containing oxide slag (a spent SCR catalyst, with a TiO₂ content of 84.9 wt. %), diamond wire saw silicon powder (Si sludge, with a Si content of 90.2 wt. %) generated from the photovoltaic industry, and slagging fluxes (CaO, SiO₂ and MgO) were subject to reduction smelting together at a temperature of 1773 K under an argon atmosphere for 4 hours, and a bulk Si—Ti intermediate alloy and a residual slag were obtained by slag-metal separation. During the reduction smelting, a mass ratio of the titanium-containing oxide slag to the diamond wire saw silicon powder was controlled to be 2:1, and CaO, SiO₂ and MgO were added in such an amount that composition of the initial slag before reduction melting was 20 wt % CaO, 4 wt % SiO₂, 56 wt % TiO₂ and 20 wt % MgO. The main phases in the bulk Si—Ti intermediate alloy were titanium-silicon intermetallic compounds TiSi and TiSi₂ with a Ti content of 53.7 wt. %;
step 2, the bulk Si—Ti intermediate alloy obtained in the step 1 was crushed into Si—Ti intermediate alloy particles with a particle size less than 4 mm;
step 3, the Si—Ti intermediate alloy particles obtained in the step 2 were used as an anode, metallic nickel as a cathode, metallic titanium as a reference electrode, NaCl—KCl—NaF (with a molar ratio of NaCl:KCl:NaF being 50.6:49.4:5) as a molten salt, and 1 mol % K₃TiF₆ was added to the molten salt to control a valence state of titanium to +3 during molten salt electrolysis which was carried out under a high-purity argon atmosphere (99.999%) at a temperature of 973 K by a potentiostatic method (with a constant potential of 350 mV). In the electrochemical process of the molten salt, Ti in the Si—Ti intermediate alloy particles dissolved at the anode and deposited at the cathode, while Si in the Si—Ti intermediate alloy particles fell off from the anode as metallic silicon powder; and
step 4, the anode and the cathode in the step 3 were taken out of the molten salt under high-purity argon (99.999%) to obtain the metallic silicon powder and the metallic titanium below the anode and at the cathode respectively.

Although the embodiments of the present invention have been described in detail with reference to the accompanying drawings, the present invention is not limited thereto, and various modification may be made within the knowledge of those of ordinary skill in the art without departing from the spirit of the present invention.

What is claimed is:

1. A method for preparing metallic titanium using titanium-containing oxide slag, comprising the following steps:
step 1, performing reduction smelting on titanium-containing oxide slag, low-purity silicon and slagging fluxes together at a temperature of 1773 K under an inert atmosphere for more than 4 hours, and performing slag-metal separation to obtain a bulk Si—Ti intermediate alloy and a residual slag; and controlling a mass ratio of the titanium-containing oxide slag to the low-purity silicon during the reduction smelting, so that main phases in the obtained bulk Si—Ti intermediate alloy are titanium-silicon intermetallic compounds TiSix, 0<x≤2;
step 2, crushing the bulk Si—Ti intermediate alloy obtained in the step 1 into Si—Ti intermediate alloy particles with a particle size less than 4 mm; and
step 3, using the Si—Ti intermediate alloy particles obtained in the step 2 as an anode, metallic molybdenum or metallic nickel as a cathode, metallic titanium as a reference electrode, and NaCl—KCl—NaF as a molten salt, adding Na₃TiF₆ or K₃TiF₆ to the molten salt for controlling a valence state of titanium to +3 during molten salt electrolysis, and performing molten salt electrolysis under a high-purity argon atmosphere at a temperature of 973 K, under this experimental condition, Ti in the Si—Ti intermediate alloy particles dissolved at the anode and deposited at the cathode, while Si in the Si—Ti intermediate alloy particles fell off from the anode as metallic silicon powder.

2. The method for preparing metallic titanium using titanium-containing oxide slag according to claim 1, wherein the titanium-containing oxide slag in the step 1 is oxide slag or scrap containing TiO₂, comprising titanium-containing blast furnace slag or a spent SCR catalyst.

3. The method for preparing metallic titanium using titanium-containing oxide slag according to claim 1, wherein the low-purity silicon in the step 1 is a silicon material with metallic silicon as a main component, comprising a silicon alloy, industrial silicon or diamond wire saw silicon powder (Si sludge) generated from the photovoltaic industry.

4. The method for preparing metallic titanium using titanium-containing oxide slag according to claim 1, wherein the slagging fluxes in the step 1 is a mixture of one or more of CaO, SiO₂, MgO and Al₂O₃ in a suitable proportion.

5. The method for preparing metallic titanium using titanium-containing oxide slag according to claim 1, wherein a ratio of NaCl, KCl and NaF in the NaCl—KCl—NaF molten salt in the step 3 is not limited.

6. The method for preparing metallic titanium using titanium-containing oxide slag according to claim 5, wherein a molar ratio of NaCl:KCl:NaF in the NaCl—KCl—NaF molten salt is 50.6:49.4:5.

7. The method for preparing metallic titanium using titanium-containing oxide slag according to claim 1, wherein Na₃TiF₆ or K₃TiF₆ is added to the molten salt in the step 3 in any molar percentage.

8. The method for preparing metallic titanium using titanium-containing oxide slag according to claim 7, wherein Na₃TiF₆ or K₃TiF₆ is added to the molten salt in the step 3 in a molar percentage of 1 mol %.

9. The method for preparing metallic titanium using titanium-containing oxide slag according to claim 1, wherein the molten salt electrolysis in the step 3 is performed by a galvanostatic method or a potentiostatic method.
